(19) United States
(12) Patent Application Publication
(10) Pub. No.: US 2004/0034532 A1
(43) Pub. Date: Feb. 19, 2004

(54) Filter architecture for rapid enablement of voice access to data repositories

(76) Inventors: Sugata Mukhopadhyay, Chelmsford, MA (US); Adam Jenkins, Somerville, MA (US); Ranjit Desai, Sudbury, MA (US); Jayanta K. Dey, Cambridge, MA (US); Rajendran M. Sivasankaran, Somerville, MA (US); Michael Swain, Newton, MA (US); Phong T. Ly, Somerville, MA (US)

Correspondence Address: LACASSE & ASSOCIATES, LLC, 1725 DUKE STREET, SUITE 650, ALEXANDRIA, VA, 22314, US

(21) Appl. No.: 10/219,458

(22) Filed: Aug. 16, 2002

(51) Int. Cl. G10L 21/00

(52) U.S. Cl. 704/270.1

(57) ABSTRACT

A combination of a series of filters and a specification language is used to rapidly enable voice access to an external data repository. The filters include a data-to-voice filter operating on data values that flow from the data repository to a communication system, a voice-to-data filter capturing voice inputs and storing data related to such inputs in the data repository, an utterance filter normalizing spoken data inputs in a particular format, a validation filter checking values returned by the speech recognizer, and a data description filter creating spoken formats of data labels or descriptions. Also included is a pair of dictionaries: name pronunciation dictionary for ensuring correct pronunciation of words and a name grammar dictionary providing variations associated with a name.

### BACKGROUND OF THE INVENTION

1. Field of Invention

The present invention relates generally to the field of network-based communications and speech recognition. More specifically, the present invention is related to a system architecture for voice-based access to external data repositories.

2. Discussion of Prior Art

VoiceXML, short for voice extensible markup language, allows a user to interact with the Internet through voice-recognition technology. Instead of a traditional browser that relies on a combination of HTML and computer input devices (i.e., keyboard and mouse), VoiceXML relies on a voice browser and/or the telephone. Using VoiceXML, the user interacts with a voice browser by listening to audio output (that is either pre-recorded or computer-synthesized) and submitting audio input through the user's natural speaking voice or through a keypad, such as a telephone.

VoiceXML allows phone-based communication (via a network 101 such as a PSTN, PBX, or VoIP network) with Internet applications. A typical voice application deployment using VoiceXML is shown in FIG. 1, and consists of five basic software components:

i. an application speech recognizer (ASR) 102 that converts recognized spoken words into binary data formats,

ii. a text-to-speech (TTS) engine 104 that converts binary data into spoken audio for output, and

iii. a VoiceXML browser 106 that interprets and executes VoiceXML code, interacts with the user, the ASR 102 and TTS 104 as well as record and playback audio files.

iv. a voice application server 108 that dynamically generates VoiceXML pages for VoiceXML browser 106 to interpret and execute.

v. one or more data stores 110 (accessed via voice application server 108) for reading and storing data that the user manipulates via voice commands.

The VoiceXML browser 106 controls the telephony hardware, the TTS 104 and the ASR 102 engines. All of these are typically (but not necessarily) situated on the same hardware platform. On receipt of a call, the browser 106 also starts a session with the voice application server 108. The voice application server 108 is typically (but not necessarily) situated on hardware separate from the VoiceXML browser hardware, and VoiceXML pages sent over the HTTP protocol are the sole means of communication between 108 and 106. Finally, for any significant voice application, the voice application server 108 has to deal with dynamic data in both the outbound (data intended for readout over the phone) and inbound (data recognized from user utterances) directions. This necessitates the voice application server to interact with data stores 110, wherein the data stores are of diverse kinds and are in various distributed locations. The interaction mechanisms between the voice application server 108 and the data stores 110 could be arbitrarily complex. However, it is beneficial for the voice application server 108 to hide these complex interactions from the voice browser with which it communicates entirely using standard VoiceXML.

While VoiceXML offers significant opportunities in extending Web application development techniques to telephony application development, traditional voice application deployments involving external data repositories have a lot of drawbacks, some of which are listed below:

i. Application development is slow and error-prone since a developer has to define system interactions (such as prompt and reprompting messages) and data format interchanges for every data element that is phone enabled.

ii. Even when the underlying core VoiceXML application remains the same, redeploying it in another environment is laborious since the data elements and formats are different between installations, leading to significant configuration efforts described in (i).

Additionally, in traditional voice enabling prior art systems using VoiceXML, there is no separation between the behavioral specification and the program logic, thereby rendering such systems slow, laborious and error-prone.

The Marx et al. U.S. Pat. No. 6,173,266 B1 describes, in general, an interactive speech application using dialog modules. Marx provides for dialog modules for accomplishing a pre-defined interactive dialogue task in an interactive speech application. A graphical user interface represents the stored plurality of modules as icons and is selected based upon a user's inputs. The icons can also be graphically interconnected into a graphical representation of the call flow of the interactive speech application, and the interactive speech application is generated based upon the graphical representation.

Whatever the precise merits, features and advantages of the above cited reference, it does not achieve or fulfill the purposes of the present invention.

### SUMMARY OF THE INVENTION

The present invention describes a system and method for rapidly enabling voice access to a collection of external data repositories. The voice access enablement involves both the readout of data from data sources as well as the updating of existing data and creation of new data items. The system and method of the present invention circumvents the above mentioned prior art problems using: (i) a filter architecture, and (ii) a specification language for describing high-level behavior, which is a more natural form of reasoning for such voice applications. These behavioral specifications are automatically translated into VoiceXML by the system of the present invention. This allows for easy configuration of voice-based data exchange with enterprise applications without rewriting the core application.

Other benefits of the present invention's separation of the behavioral specification from program logic include: ease of personalization (in one embodiment, individual users are able to have their own specification override the system specifications), and internationalization and multiple language support (in an extended embodiment, specifications for a variety of languages can be developed and maintained in parallel).

### BRIEF DESCRIPTION OF THE DRAWINGS

FIG. 1 illustrates a general architecture of a VoiceXML based communications system.

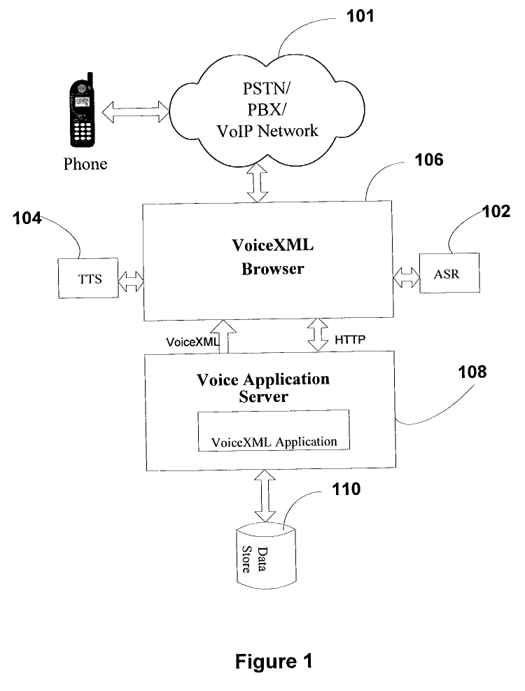

FIG. 2 illustrates the system of the present invention showing various filters and dictionaries working in conjunction with a core voice module.

FIGS. 3a-c collectively illustrate the functionality of the present invention's D2V filter.

FIGS. 4a-c collectively illustrate the functionality of the present invention's V2D filter.

FIGS. 5a-b collectively illustrate the functionality of the present invention's utterance filter.

FIGS. 6a-c collectively illustrate the functionality of the present invention's validation filter.

FIGS. 7a-d collectively illustrate the functionality of the present invention's data description filter.

FIG. 8 illustrates a DTD defining the specification language used to create behavioral specifications is an extensible markup language (XML) application.

FIG. 9 illustrates a sample form created using the present invention's filters and dictionaries implementing a calendar event in a sales force automation application.

FIG. 10 illustrates the actual field specification for the sample form of FIG. 9.

### DESCRIPTION OF THE PREFERRED EMBODIMENTS

While this invention is illustrated and described in a preferred embodiment, the invention may be produced in many different configurations, forms and materials. There is depicted in the drawings, and will herein be described in detail, a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the present invention.

A voice module is a voice application that performs a specific function, e.g., reading out email, updating a personal information manager (PIM), etc. In order to perform the function, the voice module has to interact with specific data repositories. Depending on individual installation needs and the backend enterprise system with which the voice module exchanges data, there are a number of data fields, voice prompts, etc., that need to configured. The voice module enables data, normally formatted for visualizing on a terminal device (such as a desktop, personal digital assistant or PDA, TV, etc.) and keyboard-based entry, to be transformed suitably for listening on the phone and telephone entry using voice and/or phone keys.

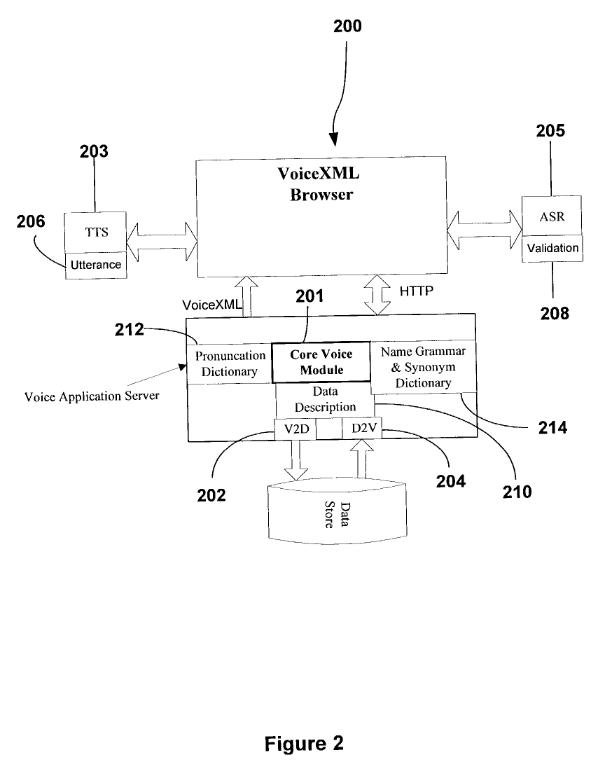

FIG. 2 illustrates the present invention's filter architecture 200, including a specification language that enables these transformations. The filter architecture allows filters (written in the specification language) to be “plugged into” the voice module 201 for quick and easy configuration (or reconfiguration) of the system. That is, the voice modules 201 provide the “core” application functionality, while the filters provide a mechanism to customize the behavior of the default voice module to address text-to-speech (TTS) 203 and automatic speech recognition (ASR) 205 idiosyncrasies and source data anomalies.

Filter Architecture:

This invention describes five classes of filters associated with the filter architecture 200 are data-to-voice (D2V) filter 204, voice-to-data (V2D) filter 202, utterance filter 206, validation filter 208, and data description filter 210. The two dictionaries associated with the filter architecture 200 are pronunciation dictionary 212 and name grammar and synonym dictionary 214. A brief description of the functionality associated with the five filters and the two dictionaries are given below.

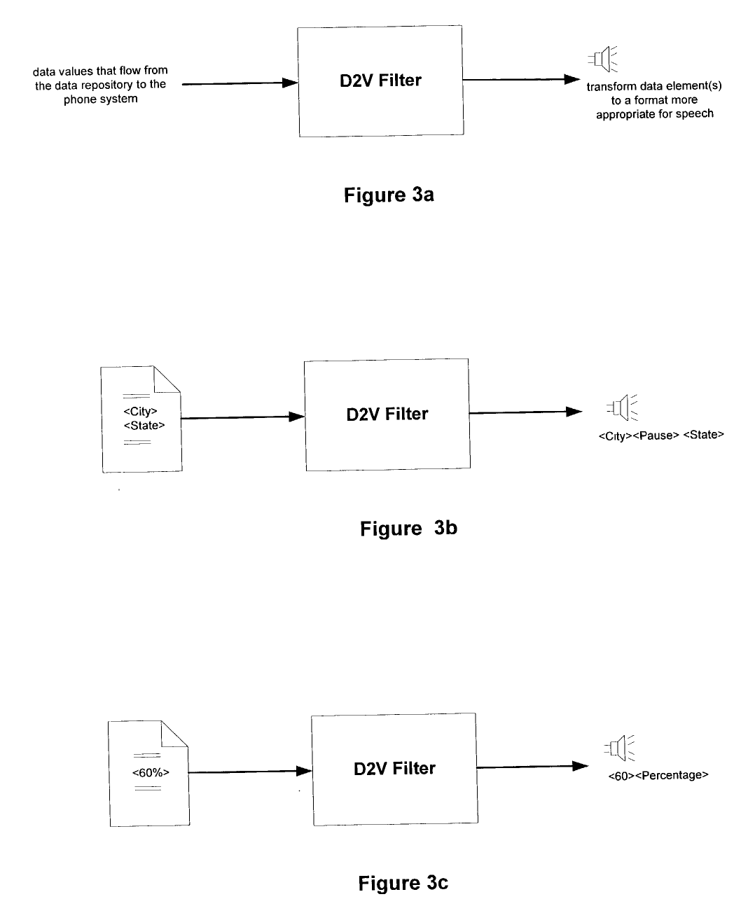

D2V Filter: As shown in FIG. 3a, the D2V class of filters operates on data values that flow from the data repository to the phone system, transforming data element(s) to a format more appropriate for speech. FIGS. 3b and 3c illustrate specific examples showing how a D2V filter works. FIG. 3b illustrates an example, wherein the “<city>” and “<state>” elements in a database are input to the filter which combines these elements before being spoken simultaneously as “<city><pause><state>”. FIG. 3c illustrates another example, wherein a data field that contains a percentage <figure> has the word “percent” appended to the <figure> when spoken out.

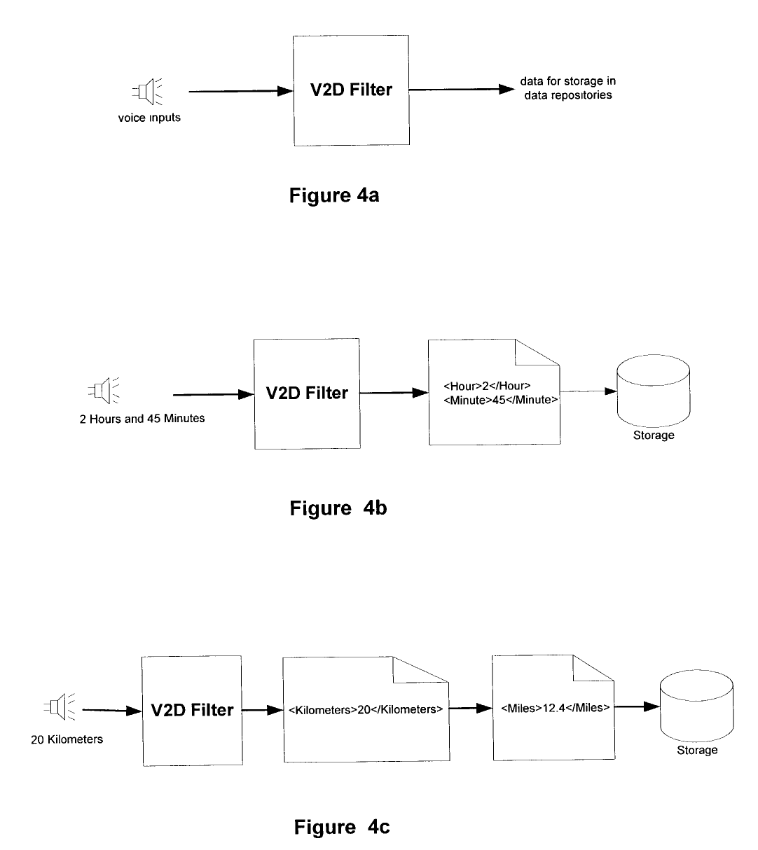

V2D Filter: FIG. 4a illustrates the operational features of the V2D class of filters. This type of filter operates on data values in the reverse direction of the D2V filter, from being captured via voice to being entered into the data repository. FIGS. 4b and 4c illustrate specific examples showing how the V2D filter works. FIG. 4b illustrates a V2D filter that splits a single spoken element such as “2 hours and 45 minutes” and stores it into two data elements called “Hours” and “Minutes”. FIG. 4c illustrates another example, wherein a V2D filter converts data entered in “Kilometers” into “Miles” before storing the value in a data repository.

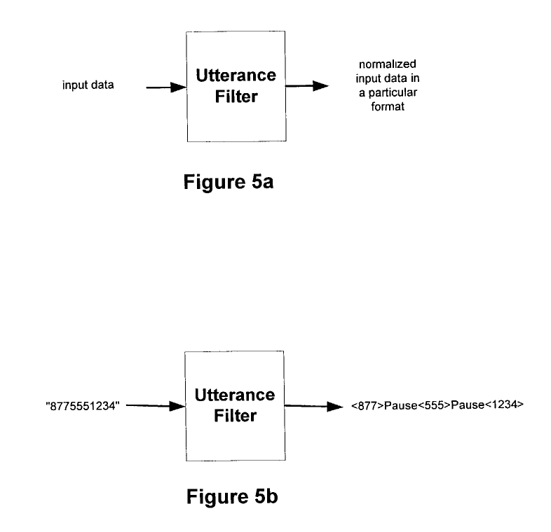

Utterance Filter: FIG. 5a illustrates the functionality associated with the utterance filter class. When the speech recognizer recognizes a spoken data value, it normalizes and returns the value in a certain format. FIG. 5b illustrates a specific example, wherein an utterance filter can be applied to a phone number value that is returned as “8775551234” such that when the value is spoken back to the user, the data elements are represented as “877<pause>555<pause>1234”. As another example, a spoken value of “half” may be read to the user as “0.5”.

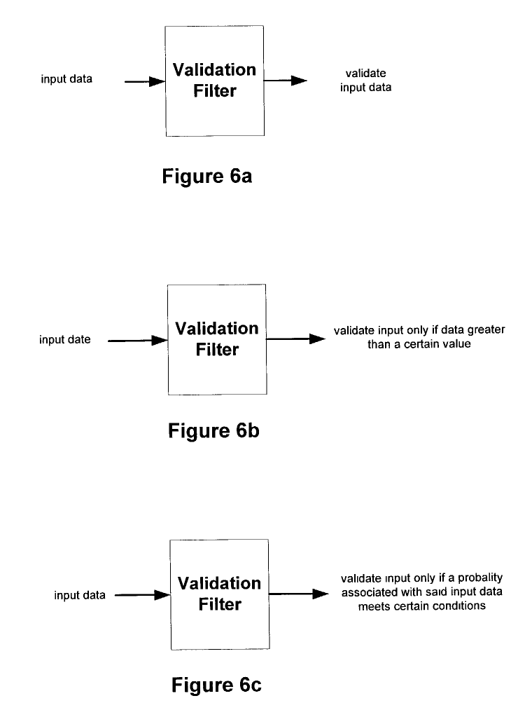

Validation Filter: FIG. 6a illustrates the functionality of the class of validation filters. This type of filter allows the voice module to check data element values returned by the speech recognizer against some validity algorithm. FIG. 6b illustrates a specific example wherein the validation filter only validates inputs that are valid dates. Thus, this would allow the voice application to reject an invalid date such as “Feb. 29, 2001” (as the year 2001 is not a leap year), but accept “Feb. 29, 2004” (as the year 2004 is a leap year).

FIG. 6c illustrates a specific embodiment wherein the validation filter is used to implement business logic (that cannot be implemented inside a speech recognizer), such as ensuring that the only valid entries to a “Probability” field are 0.2, 0.4, and 0.6, wherein the speech recognizer returns any valid fractional value between 0 and 1.

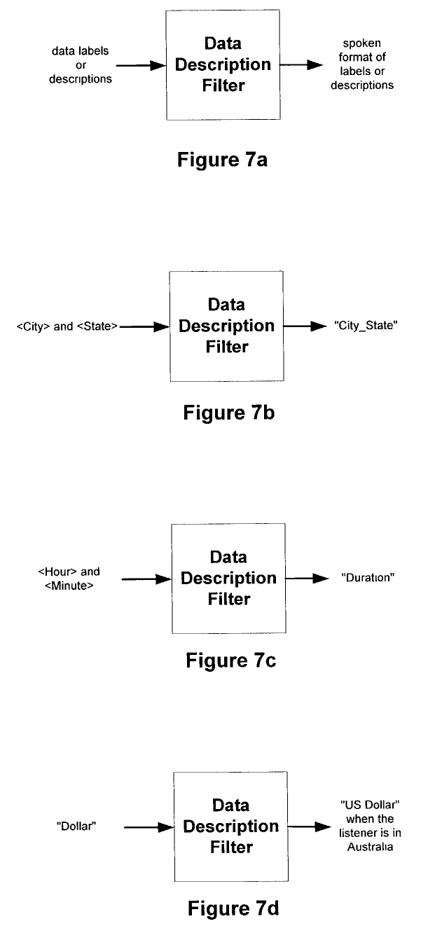

Data Description Filter: FIG. 7a illustrates the functionality associated with the data description filter class. A data description filter creates the spoken format of data labels or descriptions. FIG. 7b illustrates a specific example wherein a sample data description filter with inputs of two fields: <City> and <State> combines such inputs to create a voice label: “City_State.” Similarly, as shown in FIG. 7c, a filter may combine two labels <Hour> and <Minute> into “Duration.” Finally, yet another example involves a data description filter that converts a “Dollar” label to “US Dollar” when the listener is in Australia (FIG. 7d).

Name Pronunciation Dictionary: This class of filters ensures that a TTS engine correctly pronounces words. It is common to have different TTS engines pronounce non-English words or technical jargon differently. For a specific TTS engine, this dictionary would translate the spelling of such words into another so that the TTS engine produces the correct pronunciation. For normal words, the dictionary would simply return the original word. It should be noted that this technique also provides for an easy mechanism for internationalizing specific word sets.

Name Grammar Filter and Dictionary: This is analogous to the name pronunciation dictionary, but is intended for the Automatic Speech Recognition (ASR) engine. It ensures that for every name that the system recognizes, the user can say a variation of that name. For example, the grammar dictionary can provide alternate ways to say “Massachusetts General Hospital”, like “Mass General” or “M.G.H”. Furthermore, in the absence of a dictionary entry for a particular name, the user has to say the exact name, so entries need only be defined for names that have common variations.

Specification Language

The following part of the specification describes the specification language for describing the high-level behavior of the voice application. These behavioral specifications are automatically translated into VoiceXML by the system of the present invention. They also access the appropriate filters for configuring voice-based data exchange with enterprise applications without rewriting the core application.

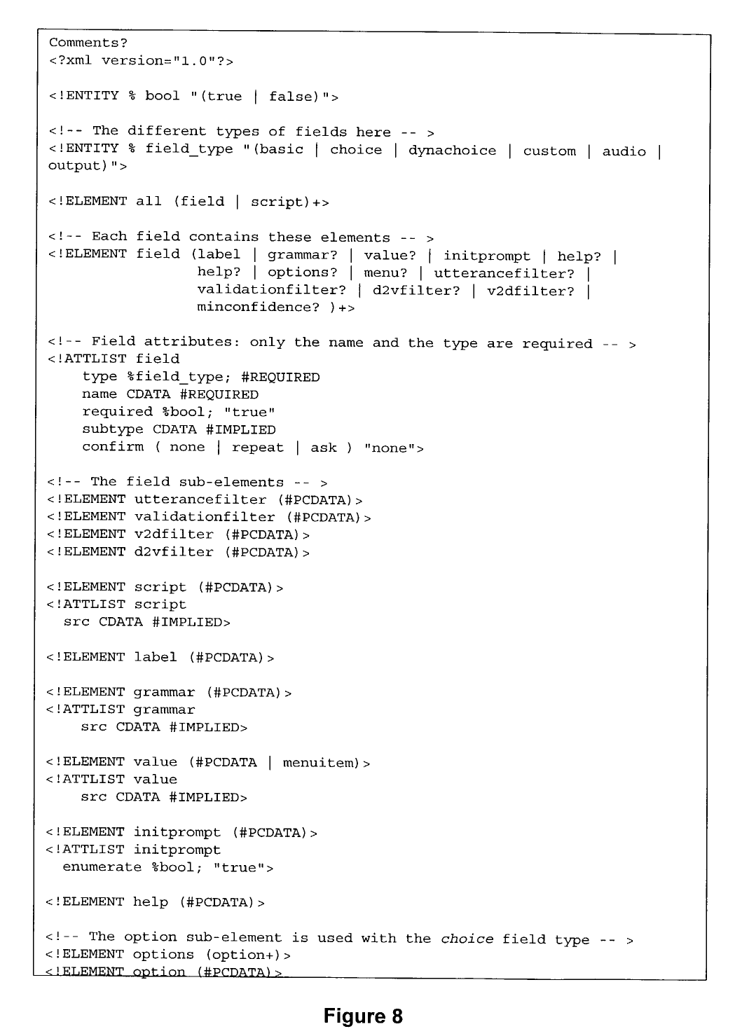

The specification language used to create behavioral specifications is an extensible markup language (XML) application, formally defined by the DTD in FIG. 8. Informally, a specification consists of a series of fields and a global section describing the control flow between them. Some of the fields are used to gather input from the user and some for presenting data to the user. Fields are typed, and the type attribute is one of the following kinds:

Basic—A field to gather input in one of the VoiceXML built in types such as date, currency, time, percentage, and number.

Choice—A field with a list of choices that the user chooses.

Dynachoice—A field that is similar to a choice, but the choices are generated dynamically at run-time. Because of dictionary filtering for ASR and TTS, each choice item has an associated label and a grammar that specifies its pronunciation and recognition respectively.

Custom—The catchall type—the specification has to provide an external grammar to recognize the input.

Audio—A field to record audio.

Output—A field to present data to the user, and not gather any data.

Other attributes for items in each of the field specifications include: the initial prompt, the help prompt, the prompt when there is no user input, an indication as to whether the field is optional, and a specification of the confirmation behavior (whether to repeat what the user said, or to explicitly confirm what the user said, or do nothing). It should be noted that specific examples of attributes are provided for describing the preferred embodiment, and therefore, one skilled in the art can envision using other attributes. Thus, the specific types of attributes used should not limit the scope of the present invention.

Finally, each field includes optional utterance filters and validation filters, whose functionality has been described previously.

### DETAILED EXAMPLE

The specification language and the filter architecture are best understood with a comprehensive example. This example will illustrate the automatic voice enabling of a simple web form.

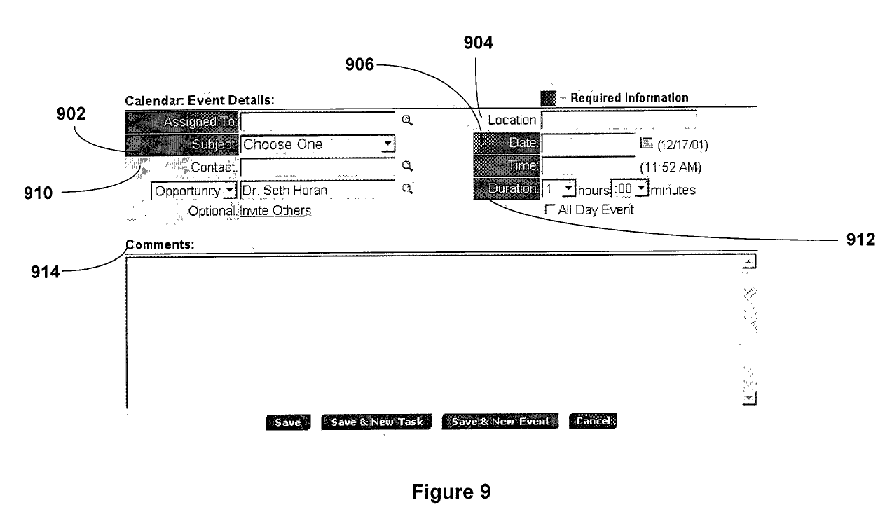

Consider the form in FIG. 9, a slightly simplified version of an actual form used to create a calendar event in a sales force automation application. This sample form illustrates the use of the different field types and filters. The form fields are voice-enabled as follows:

Subject 902: As is apparent from the figure, this field value is chosen from a list of options. The system is able to automatically generate a field description for this field. This is a “Choice” field, and the fixed set of options to choose from is also read from the data source and put into the field specification. No filters and dictionaries need be used for this field.

Location 904: This field is a free form text input field in the original web form. Since recognizing arbitrary utterances from untrained speakers is currently not possible with voice recognition technology, this field is modeled as some other type. The nature of the field lends itself to modeling as a “Choice” type as well, with the possible choices also being enumerated at the time of modeling. Therefore, in contrast to the “Subject” field, the parameters of this field are all manually specified using the field specification language. It should be noted that no filters and dictionaries are used for this field.

In an extended embodiment and for the purposes of not limiting the location as a fixed set of choices, this field is modeled as a custom type. Also, included is a specially formulated grammar that recognizes phrases indicating an event location included in the specification. A well-crafted grammar can cover a lot of possibilities as to what the user can say to specify an event location and not have the user pick from a predetermined (and rather arbitrary) list.

Date 906: This field is a “Basic” type with a subtype of date. However, for proper voice enablement, this field uses several filters.

The data source stores an existing date in a format not properly handled by the TTS engine—for example, 12/22/01 may be read out by a prior art TTS system as “twelve slash twenty two slash zero one”. An appropriate D2V filter would instead feed “December twenty two, two thousand and one” to the TTS.

An utterance filter is needed because the ASR returns recognized dates in a coded format that is not always amenable to feeding to the TTS engine (repeating a recognized answer is common practice since it assures the user that the system understood them correctly.) In general, the ASR codifies a recognized date in the YYYYMMDD format that is spoken correctly by the TTS, but certain situations cause problems. For example, ambiguous date utterances (like December twenty second) get transformed to ????1222, which is not handled well by the TTS. An utterance filter can apply application logic in such situations (like insert the current year, or the nearest year that puts the corresponding date in the future) and the TTS behaves properly.

A V2D filter is needed for reasons similar to that for the D2V filter, namely to convert ASR coded dates back to the backend data format.

Finally, a validation filter is needed to apply business logic to the date utterances at the voice user interface level (as opposed to in the backend) that are hard to incorporate in a grammar. Since this form schedules events, a validation filter would ensure that uttered dates were in the future.

Time 908: This field is also modeled as a “Basic” type with a subtype of time. D2V, V2D and utterance filters may apply, depending on the capabilities of the TTS and ASR and the way the time is formatted at the backend. A validation filter is not needed in this field.

Contact 910: This field is assigned a type “Dynachoice,” with a subtype that points a voice user interface (VUI) generator to the correct dynamic data source, namely, the source that evaluates a list of all the names in the current user's contact list. This field does not make use of filters but makes heavy use of name grammar dictionary and name pronunciation dictionaries. The former dictionary is needed since proper names have variations (people leave out middle names, use contractions like Bill Smith or Will Smith for William Smith), and the system must be able to recognize these variations and map them to the canonical name. The name pronunciation dictionary is needed to properly deal with salutations and honorifics gracefully by providing, for example, the ability to say Dr. William Smith for William Smith, M.D.

Duration Hour/Duration Minutes 912: This field brings out the power of the filter architecture in a different manner. Up until this point, the fields in the web form corresponded one-on-one with the fields described in the field specification and consequently, a single question answer interaction with the user. This is fairly essential, since a single question answer interaction is capable of reading out the old field value (if present) to the user, gathering the new value from the user and after optionally confirming it, submitting it back to the data source to update that same source field. This default transformation would be unsuitable for the duration field, as it would call for one question answer interaction to get the duration hours (after reading out the hours portion of the old duration) and another to get the minutes, whereas it is much more natural to have the user say a duration as an hour and minute value in one interaction.

A new virtual field of a custom type is introduced, which provides a grammar capable of phrases corresponding to durations, such as “one hour and thirty minutes” and “two and a half hours”. Then, a D2V filter is defined, wherein the D2V filter looks at two fields in the data source (the duration hours and the duration minutes) to come up with the TTS string to say as the initial virtual field value. Utterance and validation filters are optional, as durations returned by the ASR may be fed to the TTS without problems, and the system may or may not want to ensure that spoken durations are reasonable for events. However, a V2D filter is used as it takes the user input and breaks it down into the duration hours and duration minutes components to submit to each of the two actual fields at the backend.

Comments 914: Comments 914 is modeled as an audio field, since this is one field where the user has the freedom to enter anything.

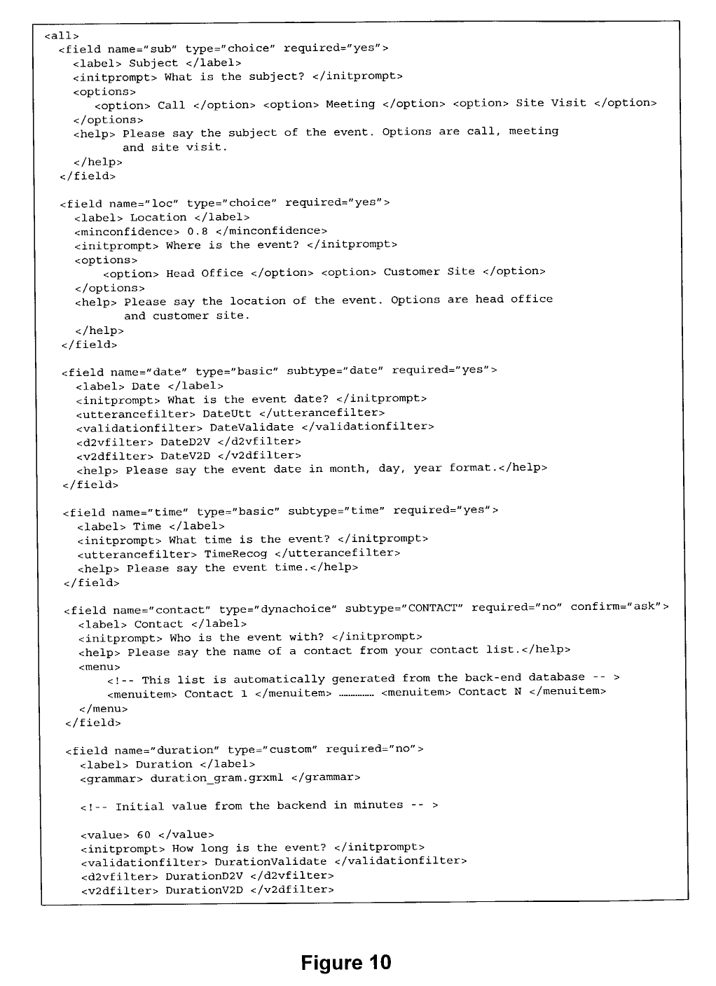

Details of how the field specification language is able to specify prompts, confirmation behavior, recognition thresholds, and mandatory versus optional fields are now described. Both the specification DTD (FIG. 8) and the actual specification incorporate these elements. FIG. 10 lists the actual field specification for this sample form.

For every field, the field specification language allows the designer to author two prompts. The initial prompt, used to prompt the user to fill in a field upon entry, is specified in the <initprompt> element. If omitted, the field name (as specified by the “name” attribute of the <field> element) is used as the initial prompt. The help text, which is read out when the user says “help” within that field, is specified using the <help> element. If omitted, the initial prompt is reused for help.

The “required” attribute on the <field> element is used to mark a field as mandatory or optional. If set to “false”, the user can use a “skip” command to omit filling in that field, and if set to “true”, the system does not honor the “skip” command.

The confirmation behavior is controlled using the “confirm” attribute of the <field> element. This attribute can take one of three values—“none”, “ask” and “repeat”. If set to “none”, the system does nothing after recognizing the user's answer, and simply moves on to the next field. If set to “ask”, the system always reconfirms the recognized answer by asking a follow-up question, in which the recognized answer is echoed back to the user, who is then expected to say “yes” or “no” in order to confirm or reject it. Upon a confirmation, the system moves on to the next field, and upon rejection, the system stays in the same field and expects the user to give a new answer. Finally, if the attribute is set to “repeat”, the system echoes the recognized answer back to the user, and then moves on to the next field without the user having to explicitly confirm or reject the answer. Of course, even in this case, if the answer recognized by the system is not accurate, the user can use a “go back” command to correct it. If this attribute is omitted, the default is “repeat”.

Finally, the specification language allows a fine-grained control over the recognition thresholds. A recognition threshold is a number between 0 and 1, and it is the minimum acceptable confidence value for a recognition result, for the ASR to deem that recognition to be successful. Lower values of the threshold result in a higher probability of erroneous recognitions, but higher values carry the risk that the ASR will be unable to perform a successful recognition on a given piece of user input, and the question will have to posed to the user again. For this reason, it is especially important that the recognition threshold be tunable on a per field basis. The element <minconfidence> contains the threshold for a given field. If omitted, the system wide confidence threshold is applied to the field.

Furthermore, the present invention includes a computer program code based product, which is a storage medium having program code stored therein, which can be used to instruct a computer to perform any of the methods associated with the present invention. The computer storage medium includes any of, but not limited to, the following: CD-ROM, DVD, magnetic tape, optical disc, hard drive, floppy disk, ferroelectric memory, flash memory, ferromagnetic memory, optical storage, charge coupled devices, magnetic or optical cards, smart cards, EEPROM, EPROM, RAM, ROM, DRAM, SRAM, SDRAM or any other appropriate static or dynamic memory, or data storage devices.

Implemented in computer program code based products are software modules for: customizing one or more customizable filter modules comprising any of, or a combination of: a) a data-to-voice filter operating on data values flowing from said data repository to said communication system, a voice-to-data filter transforming voice inputs from said communications systems to a format appropriate for storage in said data repository, an utterance filter normalizing and returning a voice input in a particular format, a validation filter for validation of data, or a data description creating spoken format of data labels of descriptions, and b) generating one or more dictionary modules for correct pronunciation of words and recognizing variations in speech inputs, wherein the generated modules interact with the browser based upon a markup based specification language.

### CONCLUSION

A system and method has been shown in the above embodiments for the effective implementation of a filter architecture for rapid enablement of voice access to data repositories. While various preferred embodiments have been shown and described, it will be understood that there is no intent to limit the invention by such disclosure, but rather, it is intended to cover all modifications and alternate constructions falling within the spirit and scope of the invention, as defined in the appended claims. For example, the present invention should not be limited by software/program, computing environment, specific computing hardware, specific types of attributes, or ability of field specification language to specify: prompts, confirmation behavior, recognition thresholds, and mandatory versus optional fields.

The above enhancements are implemented in various computing environments. For example, the present invention may be implemented on a conventional IBM PC or equivalent, multi-nodal system (e.g., LAN) or networking system (e.g., Internet, WWW, wireless web). All programming, GUIs, display panels and dialog box templates, and data related thereto are stored in computer memory, static or dynamic, and may be retrieved by the user in any of: conventional computer storage, display (i.e., CRT) and/or hardcopy (i.e., printed) formats. The programming of the present invention may be implemented by one of skill in one of several languages, including, but not limited to, C, C++, Java and Perl.

1. A communication architecture for rapid enablement of bi-directional communication between a communication device and a data repository operative with a browser, said browser interacting with an automatic speech recognizer (ASR) and a text-to-speech (TTS) engine, said architecture comprising:
a voice application server operatively linked with said data repository and said browser, said voice application server comprising:
a. one or more filters for: converting said voice inputs or validated voice inputs into an audio format for storage in said data repository, converting data in said audio format to said text inputs, and creating a spoken format from data in said data repository for rendering in said communication device,
b. one or more dictionaries for correct pronunciation of said text inputs and identifying variations in said voice inputs, and
c. one or more core voice modules providing core application functionality based upon interacting with said filters, dictionaries, and said browser to provide for rapid bi-directional communication to said data repository, said interaction between said core voice module(s) and said browser based upon a markup based specification language.

2. A communication architecture as per claim 1, wherein communication between said browser and said voice application server is over the HTTP protocol.

3. A communication architecture as per claim 1, wherein data and instructions from said voice application server are sent to said browser using VoiceXML.

4. A communication architecture for rapid enablement of bi-directional communication between a communication device and a data repository, said architecture comprising:
i. a browser interacting with:
a. an automatic speech recognizer (ASR) working in conjunction with a validation filter, said ASR receiving voice inputs from said communication device and validating said voice inputs using said validation filter, and
b. a text-to-speech (TTS) engine working in conjunction with an utterance filter, said TTS engine converting text inputs to voice outputs for rendering in said browser and said utterance filter normalizing said text inputs in a format compatible for rendering in said communication device; and
ii. a voice application server operatively linked with said data repository and said browser, said voice application server comprising:
a. one or more filters for: converting said voice inputs or validated voice inputs into an audio format for storage in said data repository, converting data in said audio format to said text inputs, and creating a spoken format from data in said data repository for rendering in said communication device,
b. one or more dictionaries for correct pronunciation of said text inputs and identifying variations in said voice inputs, and
c. one or more core voice modules providing core application functionality based upon interacting with said filters, dictionaries, and said browser to provide for rapid bi-directional communication to said data repository, said interaction between said core voice module(s) and said browser based upon a markup based specification language.

5. A communication architecture as per claim 4, wherein communication between said browser and said voice application server is over the HTTP protocol.

6. A communication architecture as per claim 4, wherein data and instructions are sent to said browser from said voice application server in a VoiceXML format.

7. A set of customizable filters and dictionaries for rapid enablement of bi-directional communication between a voice application server and a data repository, said voice application server interacting with a communication device via a browser, said filters and dictionaries interacting with a core voice module, said browser implementing an automatic speech recognition (ASR) engine and a text to speech (TTS) engine, said filters and dictionaries comprising:
i. a validation filter working in conjunction with said ASR, said ASR receiving voice inputs from said communication device and validating said voice inputs using said validation filter;
ii. an utterance filter working in conjunction with said TTS engine, said TTS engine converting text inputs to voice outputs for rendering in said browser and said utterance filter normalizing said text inputs in a format compatible for rendering in said communication device;
iii. a voice-to-data (V2D) filter for converting said voice inputs or validated voice inputs into an audio format for storage in said data repository;
iv. a data-to-voice (D2V) filter converting data in said audio format to said text inputs;
v. a data description filter creating a spoken format for data labels obtained from metadata in said data repository for rendering in said communication device;
vi. a pronunciation dictionary for correct pronunciation of said text inputs; and
vii. a name grammar and synonym dictionary for identifying variations in said voice inputs.

8. A set of customizable filters and dictionaries as per claim 7, wherein said validation filter implements appropriate business logic.

9. A set of customizable filters and dictionaries as per claim 7, wherein communication between said browser and said voice application server is over the HTTP protocol.

10. A set of customizable filters and dictionaries as per claim 7, wherein data and instructions are sent to said browser from said voice application server in a VoiceXML format.

11. A method for customizing a set of filters and dictionaries for rapid enablement of bi-directional communication between a voice application server and a data repository, said voice application server interacting with a communication device via a browser, said filters and dictionaries interacting with a core voice module, said browser implementing an automatic speech recognition (ASR) engine and a text to speech (TTS) engine, said method comprising the steps of:
i. customizing a validation filter working in conjunction with said ASR, said ASR receiving voice inputs from said communication device and validating said voice inputs using said validation filter;
ii. customizing an utterance filter working in conjunction with said TTS engine, said TTS engine converting text inputs to voice outputs for rendering in said browser and said utterance filter normalizing said text inputs in a format compatible for rendering in said communication device;
iii. customizing a voice-to-data (V2D) filter converting said voice inputs or validated voice inputs into an audio format for storage in said data repository;
iv. customizing a data-to-voice (D2V) filter converting data in said audio format to said text inputs;
v. customizing a data description filter creating a spoken format for data labels obtained from metadata in said data repository for rendering in said communication device;
vi. customizing a pronunciation dictionary correcting pronunciation of said text inputs; and
vii. customizing a name grammar and synonym dictionary identifying variations in said voice inputs.

12. A method as per claim 11, wherein said validation filter implements appropriate business logic.

13. A method as per claim 11, wherein communication between said browser and said voice application server is over the HTTP protocol.

14. A method as per claim 11, wherein data and instructions are sent to said browser from said voice application server in a VoiceXML format.

15. A method for providing rapid access to one or more data repositories based upon the interaction of one or more core voice modules with one or more filters and dictionaries, said data repositories, filters, and dictionaries distributed over a network, said method comprising:
in a transmission mode:
receiving a voice input via an external browser;
validating said voice input using said one or more filters;
identifying variations in said validated voice inputs via said one or more dictionaries;
converting said validated voice inputs and said variations in voice inputs to an audio format suitable for storage in said one or more data repositories, said conversion done via said one or more filters;
transmitting said converted validated voice inputs and variations in voice inputs in said audio format to said one or more data repositories;
in a receiving mode:
receiving, from said one or more data repositories, voice inputs in said audio format and converting said voice inputs to text inputs via said one or more filters;
correcting pronunciation of said text inputs via said one or more dictionaries;
normalizing said corrected text inputs for rendering in said external browser via said one or more filters, and
converting said normalized text inputs to speech inputs and transmitting said speech inputs to said external browser via said one or more filters.

16. A method as per claim 15, wherein said method further comprises the step of creating a spoken format from data labels obtained from metadata in said data repository, said spoken format rendered in said external communication device.

17. A method as per claim 15, wherein said transmission to said browser is in a VoiceXML format.

18. An article of manufacture comprising computer usable medium embodied therein for customizing a set of filters and dictionaries for rapid enablement of bi-directional communication between a voice application server and a data repository, said voice application server interacting with a communication device via a browser, said filters and dictionaries interacting with a core voice module, said browser interacting with an automatic speech recognition (ASR) engine and a text to speech (TTS) engine, said medium comprising:
i. computer readable program code implementing an interface customizing a validation filter working in conjunction with said ASR, said ASR receiving voice inputs from said communication device and validating said voice inputs using said validation filter;
ii. computer readable program code implementing an interface customizing an utterance filter working in conjunction with said TTS engine, said TTS engine converting text inputs to voice outputs for rendering in said browser and said utterance filter normalizing said text inputs in a format compatible for rendering in said communication device;
iii. computer readable program code implementing an interface customizing a voice-to-data (V2D) filter converting said voice inputs or validated voice inputs into an audio format for storage in said data repository;
iv. computer readable program code implementing an interface customizing a data-to-voice (D2V) filter converting data in said audio format to said text inputs;
v. computer readable program code implementing an interface customizing a data description filter creating a spoken format from said from data in said data repository for rendering in said communication device;
vi. computer readable program code implementing an interface customizing a pronunciation dictionary correcting pronunciation of said text inputs; and
vii. computer readable program code implementing an interface customizing a name grammar and synonym dictionary identifying variations in said voice inputs.
